(19) United States
(12) Patent Application Publication
(10) Pub. No.: US 2025/0209545 A1
(43) Pub. Date: Jun. 26, 2025

(54) GENERATING USER PROFILE SUMMARIES BASED ON VIEWER INTENT

(71) Applicant: Microsoft Technology Licensing, LLC, Redmond, WA (US)

(72) Inventors: Aman Gupta, San Francisco, CA (US); Ning Jin, Sunnyvale, CA (US); Lu Chen, Sunnyvale, CA (US); Mahesh Vishwanath, Cupertino, CA (US); Qiannan Yin, Sunnyvale, CA (US); Yao Pan, Mountain View, CA (US); Xincen Yu, Palo Alto, CA (US)

(21) Appl. No.: 18/747,898

(22) Filed: Jun. 19, 2024

Related U.S. Application Data
(60) Provisional application No. 63/614,123, filed on Dec. 22, 2023.

(51) Int. Cl. G06Q 50/00; H04L 67/1396; H04L 67/306

(52) U.S. Cl. CPC G06Q 50/01; H04L 67/1396; H04L 67/306

(57) ABSTRACT

In example embodiments, specialized machine learning techniques may be utilized to automatically create summaries for viewers based at least partially on viewer intent. Viewer intent refers to the intention of the viewer with respect to performing a particular action in a computer system, namely what the viewer is attempting to accomplish. In some example embodiments, this viewer intent may be expressed in the form of a plurality of different intent categories, each providing, at a high level, what the viewer intends to accomplish. Examples of such categories in a social networking service include “job seeker,” “information gatherer,” “salesperson,” and “recruiter.”

### CROSS-REFERENCE TO RELATED APPLICATIONS

This application claims priority to U.S. Provisional Application No. 63/614,123, filed Dec. 22, 2023, entitled “GENERATING USER PROFILE SUMMARIES BASED ON VIEWER INTENT,” hereby incorporated herein by reference in its entirety.

### TECHNICAL FIELD

The present disclosure generally relates to technical problems encountered in machine learning. More specifically, the present disclosure relates to generating user profile summaries based on user intent.

### BACKGROUND

The rise of the Internet has occasioned two disparate yet related phenomena: the increase in the presence of online networks, such as social networking services, with their corresponding user profiles and posts visible to large numbers of people; and the increase in the use of such online networks for various forms of communications.

### BRIEF DESCRIPTION OF THE DRAWINGS

Some embodiments of the technology are illustrated, by way of example and not limitation, in the figures of the accompanying drawings.

FIG. 1 is a bloc diagram illustrating a GAN model in accordance with an example embodiment.

FIG. 2 is a block diagram showing the functional components of a social networking service, including a data processing module referred to herein as a search engine, for use in generating and providing search results for a search query, consistent with some embodiments of the present disclosure.

FIG. 3 is a block diagram illustrating the application server module of FIG. 1 in more detail, in accordance with an example embodiment.

FIG. 4 is a screen capture illustrating a first user interface, in accordance with an example embodiment.

FIG. 5 is a screen capture illustrating a second user interface, in accordance with an example embodiment.

FIG. 6 is a flow diagram illustrating a method for generating a summary of a user profile, in accordance with an example embodiment.

FIG. 7 is a block diagram illustrating a software architecture, in accordance with an example embodiment.

FIG. 8 illustrates a diagrammatic representation of a machine in the form of a computer system within which a set of instructions may be executed for causing the machine to perform any one or more of the methodologies discussed herein, according to an example embodiment.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

In various types of computer systems, users may view the user profiles of other users. In such instances, the users who are doing the viewing may be termed “viewers.” For purposes of this document, the term “viewer” shall refer to a user who is either actively viewing a user profile or who is determined to be a possible active viewer of a particular user profile in the future. Viewers may view the user profiles in many different contexts/portals, and such viewing may occur either through explicit action (e.g., navigating to a user profile page for a user) or implicit action (e.g., being presented with a user profile via a notification indicating that the user profile may be of interest to the viewer). Regardless of the context in which the user profile may be viewed, however, a user will be considered a viewer even if the user does not actually ever see the user profile, as long as the user is being considered as being someone to whom all or a portion of the user profile is to be displayed. This is in contrast to a “viewee,” which as described later will refer to a user whose user profile is being considered for display. Machine learning models are often used in online networks for a number of different purposes. Certain machine learning models rely upon information from user profiles, or user actions in response to seeing information from user profiles, in making what are commonly called “downstream” recommendations. A downstream recommendation is one that occurs after an initial task or process. For example, a viewer may be presented with certain recommendation actions (such as applying for a job), but this recommendation may be a downstream recommendation based on the viewer having been linked to or otherwise matched with another user (the viewee). This linkage between the users, However, may have been based on matching the user profile of the viewee with information known about the viewer.

User profiles, however, can be long and unwieldy, and the amount and form of the information within them may not be consistent from user profile to user profile. This can lead to incorrect matching of user profiles of viewees to viewers, which can then adversely impact the reliability of a downstream recommender model.

Additionally, it can be technically challenging to accurately match viewers to viewee, as the viewer may have interacted with the online network in a number of different platforms or contexts.

One solution would be to use machine learning algorithms to automatically generate summaries of user profiles. Such machine learning algorithms, however, suffer from technical drawbacks that render their output ineffective, at least when applied on a large scale to many different user profiles. This is partially due to the aforementioned inconsistencies across user profiles, but also partially due to the fact that one viewer may find a particular generated summary relevant while another may find the same particular generated summary irrelevant.

In example embodiments, specialized machine learning techniques may be utilized to automatically create personalized summaries for viewers based at least partially on viewer intent. Viewer intent refers to the intention of the viewer with respect to performing a particular action in a computer system, namely what the viewer is attempting to accomplish. In some example embodiments, the intention of the viewer is specific to an objective capable of being performed by a social network. In some example embodiments, this viewer intent may be expressed in the form of a plurality of different intent categories, each providing, at a high level, what the viewer intends to accomplish. Examples of such categories in a social networking service include “job seeker,” “information gatherer,” “salesperson,” and “job recruiter.”

### Description

In various example embodiments, personalized summaries of online content may be generated for users based on viewer intent. These personalized summaries may be generated using specialized machine learning techniques that will be described herein.

It should be noted that in some examples it may be possible for a viewer to be classified into multiple intents. For example, a particular user may be both a job seeker and a salesperson. In some example embodiments, a ranking is performed to rank multiple user intents for the same user, such that the user intent with the highest ranking can be used as the basis for the summarization that will occur. The ranking may be based on the likelihood that the user has the corresponding user intent, but could also be based on other factors. Alternatively, rather than selecting a single user intent for a user who has multiple user intents, a new category may be established that combines each of the multiple user intents. Thus, for example, a category of user intent may be term “job seeker/salesperson” as a distinct category from either “job seeker” or “salesperson” alone, and also distinct from other combinations such as “job seeker/information gatherer.”

In other example embodiments, rather than using only the intent with the highest ranking as the basis for the summarization, multiple intents within the ranking are used to generate summarizations and then the summarizations themselves are ranked. For example, if a user is determined to have 7 different intents, each at differing intensity levels, then these 7 intents are ranked. Rather then just summarizing the top ranked of these 7 intents, some or all of the rest of the intents in the ranking can also be summarized and the ranking may be used in determining which summary or summaries to present to the user, as opposed to determining which summary or summaries to generate.

In some additional example embodiments, a threshold may be used for the ranking so that some, but not necessarily all, of the ranked intents are used as a basis for summarization. For example, the threshold may indicate that the top 5 ranked intents are used for summarization. Alternatively, the threshold may be based on a score indicative of the level or intensity of the intent, such as indicating that ant intent having a score higher than 0.6 will be used as a basis for summarization.

It should be noted that the first machine learning model may be specifically designed to create personal summaries of user profiles, and the present disclosure will discuss its application to the creation of personal summaries of user profiles, however one of ordinary skill in the art will recognize that similar techniques can be applied to any type of content, not just user summaries, and thus nothing in this disclosure shall be taken as limiting the scope of protection to the summarization of user profiles specifically, unless explicitly stated. Examples of other content to which the described techniques could be applied include articles, posts, presentations, messages, etc. Additionally, there is no requirement that the viewer or viewee be an individual person. For example, the viewer or viewee could be some other form of entity, such as a company or organization.

Additionally, use cases are foreseen where the summarization occurs not just in cases where a profile is going to be viewed, but also in cases where summarizations of content may be relevant more generally. Examples include making recommendations of people (which may include summaries of those people's profiles) in emails (such as people you may know emails, or people who have followed you emails), my-network recommendations, search pages, talent searches, educational course recommendations, sales leads, etc.

More particularly, a first machine learning model may be used to classify the viewer into a viewer intent category. A second machine learning model may then be used to actually generate the summary of a user profile whose information is to be presented to the viewer. This improves upon summaries generated by other machine learning models since it allows the summaries to be customized for the viewer, and thus makes the summary more relevant for downstream recommendations pertaining to the user. Thus, for example, a viewer who is a job seeker will see a different summary of user A's profile than a viewer who is a job recruiter. Thereafter, based on the customized summary, the viewer may be recommended to apply for a job at a company at which the viewee works.

The first machine learning model, which may be referred to herein as a viewer intent model, may be trained by any model from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbor, decision trees, and hidden Markov models.

In an example embodiment, the machine learning algorithm used to train the viewer intent model may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function. Furthermore, the viewer intent model is able to pull data from viewer activities across a number of different platforms or contexts within an online network to determine the viewer's intent. For example, these different platforms may include a viewer's engagement with a social network feed, with email, and posts.

In some example embodiments, the training of the viewer intent model may take place as a dedicated training phase. In other example embodiments, the viewer intent model may be retrained dynamically at runtime by the viewer providing live feedback.

In an example embodiment, the viewer intent model is trained to classify a viewer's intent with respect to actions taken in an online network. The actual classification of a particular viewer's intent may be performed at the time that the online network wishes to present information corresponding to a user profile (such as a summary of the user profile) to the viewer. The online network may feed various information about the viewer into the viewer intent model to obtain a classification. This information may include one or more features corresponding to the viewer, such as the viewer's own user profile, viewer interaction history (e.g., actions taken by the viewer in the online network, such as performing job searches), and/or other information of or pertaining to the viewer, taken from potentially multiple different platforms/contexts within an online network. The information passed to the viewer intent model may be known generally as “input features”

In some example embodiments, one or more of these input features are themselves embeddings. An embedding is a representation of a value of a feature in a dimensional space, which allows the machine learning model to perform distance-related measurements when comparing two values of features. Essentially the process of embedding involves learning how to convert discrete symbols, such as words, into continuous representations in a dimensional space. For example, a sequence of user profile data (e.g., location, school, skills) can be embedded into a single vector. In this context, vector refers to the computer science version of the term, in other words an array of values, as opposed to the mathematical version of the term (meaning a line with a direction). The vector of values can represent coordinates in an n-dimensional space (with n being the number of values in the vector).

Embeddings are typically created using their own machine learning models, or at least specialized layers within other machine learning models. These embedding models/layers therefore rely on extensive training of their own, on top of the training needed for the machine learning model in which the embeddings will be fed as input.

In an example embodiment, a generative artificial intelligence (GAI) model is used to generate embeddings, eliminating the need for a separately trained embedding model or layer. This may be accomplished by, for example, using a large language model (LLM) by converting input features such as user profile and interaction history to text.

GAI refers to a class of artificial intelligence techniques that involves training models to generate new, original data rather than simply making predictions based on existing data. These models learn the underlying patterns and structures in a given dataset and can generate new samples that are similar to the original data.

Some common examples of generative AI models include Generative Adversarial Networks (GANs), Variational Autoencoders (VAEs), and autoregressive models. These models have been used in a variety of applications such as image and speech synthesis, music composition, and the creation of virtual environments and characters.

When a GAI model generates new, original data, it goes through the process of evaluating and classifying the data input into it. In an example embodiment, the product of this evaluation and classification is utilized to generate embeddings for data, rather than using the output of the generative AI model directly. Thus, for example, while (as will be described below) a GAI model may be used to generate a summary for a user profile, it could also be used to generate an embedding for the user profile. In such an instance, an embedding for the user profile is generated based on the intermediate work product of the GAI model that it would produce when going through the motions of generating the summary for the user profile.

More particularly, the GAI model is used to generate user understanding in the form of the embeddings, rather than (or in addition to) generating summaries itself.

In an example embodiment, the user understanding/embeddings generated pertain to user profiles of viewers, as well as potentially other features of viewers, in an online network, such as a social networking service.

In an example embodiment, the GAI model is implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance.

The bidirectional encoder may be implemented as a Bidirectional Long Short-Term Memory (BILSTM) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer-to-language modelling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once, and thus is considered to be bidirectional (although one could argue that it is, in reality, non-directional). This characteristic allows the model to learn the context of a piece of information based on all of its surroundings.

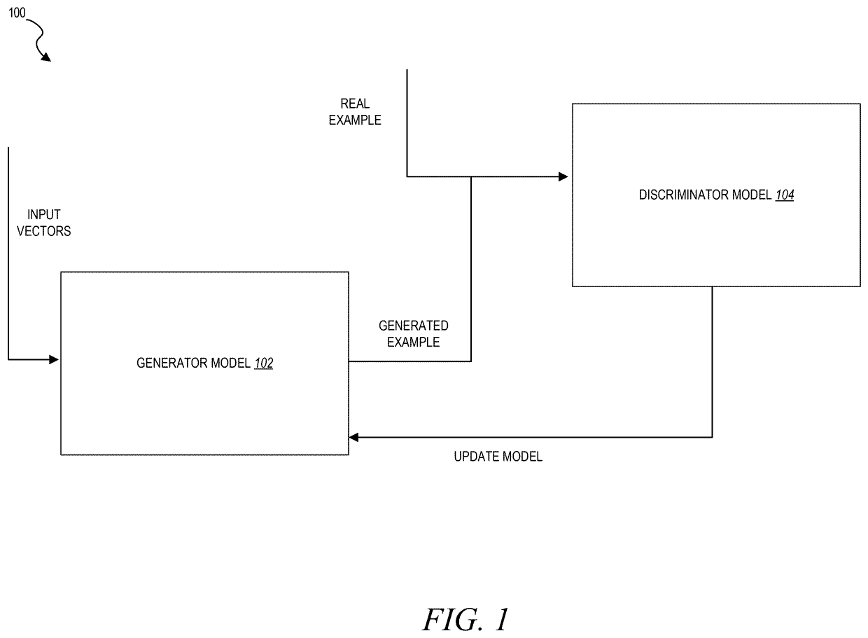

In other example embodiments, a GAN embodiment may be used. FIG. 1 is a block diagram illustrating a GAN model 100, in accordance with an example embodiment. GAN is a supervised machine learning model that has two sub-models: a generator model 102 that is trained to generate new examples, and a discriminator model 104 that tries to classify examples as either real or generated.

The two models are trained together in an adversarial manner (using a zero-sum game, according to game theory), until the discriminator model 104 is fooled roughly half the time, which means that the generator model 102 is generating plausible examples.

The generator model 102 takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space, or a vector space comprised of latent variables. Latent variables, or hidden variables, are those variables that are important for a domain but are not directly observable.

The discriminator model 104 takes an example from the domain as input (real or generated) and predicts a binary class label of real or fake (generated).

Generative modeling is an unsupervised learning problem,, although a clever property of the GAN architecture is that the training of the generative model 102 is framed as a supervised learning problem.

The two models, the generator model 102 and the discriminator model 104, are trained together. The generator model 102 generates a batch of samples, and these, along with real examples from the domain, are provided to the discriminator and classified as real or fake.

The discriminator model 104 is then updated to get better at discriminating real and fake samples in the next round, and importantly, the generator is updated based on how well, or not, the generated samples fooled the discriminator.

In another example embodiment, the GAI model is a Variational AutoEncoders (VAEs) model. VAEs comprise an encoder network that compresses the input data into a lower-dimensional representation, called a latent code, and a decoder network that generates new data from the latent code.

In either case, the GAI model contains a generative classifier, which can be implemented as, for example, a naïve Bayes classifier. It is the output of this generative classifier that can be leveraged to obtain embeddings, which can then be used as input to a separately trained machine learning model.

The above generally describes the overall process as used during inference-time (when the viewer intent model determines an intent for a particular viewer), but the same or similar process can be performed during training as well. Specifically, for some features of the training data used to train the viewer intent model, those features are passed into the GAI model to generate an embedding that provides understanding for those corresponding features.

The actual summarization of the user profile may be performed by a second machine learning model. The second machine learning model may be a GAI model (in some example embodiments, it may be the same GAI model used to generate the embeddings).

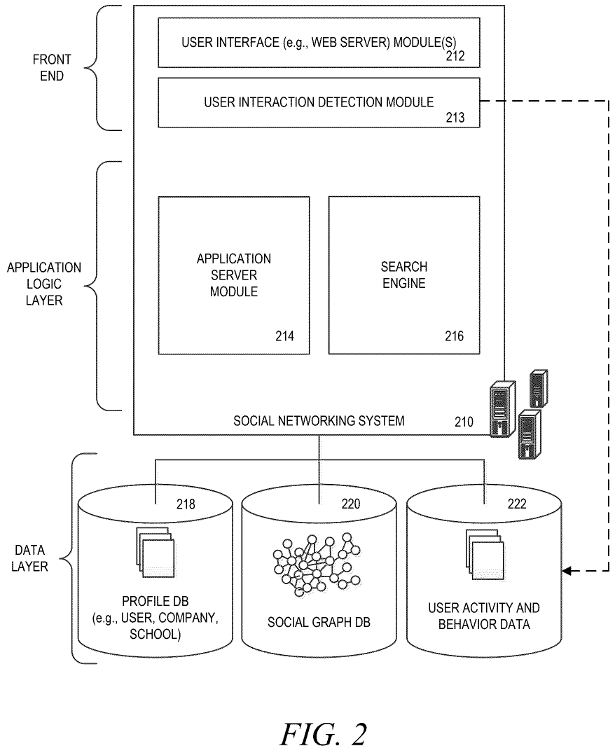

FIG. 2 is a block diagram showing the functional components of a social networking service, including a data processing module referred to herein as a search engine, for use in generating and providing search results for a search query, consistent with some embodiments of the present disclosure.

As shown in FIG. 2, a front end may comprise a user interface module 212, which receives requests from various client computing devices and communicates appropriate responses to the requesting client devices. For example, the user interface module(s) 212 may receive requests in the form of Hypertext Transfer Protocol (HTTP) requests or other web-based Application Program Interface (API) requests. In addition, a user interaction detection module 213 may be provided to detect various interactions that users have with different applications, services, and content presented. As shown in FIG. 2, upon detecting a particular interaction, the user interaction detection module 213 logs the interaction, including the type of interaction and any metadata relating to the interaction, in a user activity and behavior database 222.

An application logic layer may include one or more various application server modules 214, which, in conjunction with the user interface module(s) 212, generate various user interfaces (e.g., web pages) with data retrieved from various data sources in a data layer. In some embodiments, individual application server modules 214 are used to implement the functionality associated with various applications and/or services provided by the social networking service.

As shown in FIG. 2, the data layer may include several databases, such as a profile database 218 for storing profile data, including both user profile data and profile data for various organizations (e.g., companies, schools, etc.). Consistent with some embodiments, when a person initially registers to become a user of the social networking service, the person will be prompted to provide some personal information, such as his or her name, interests, educational background (e.g., schools, majors, matriculation and/or graduation dates, etc.), employment history, skills, professional organizations, and so on. This information is stored, for example, in the profile database 218. Similarly, when a representative of an organization initially registers the organization with the social networking service, the representative may be prompted to provide certain information about the organization. This information may be stored, for example, in the profile database 218 or another database (not shown). In some embodiments, the profile data may be processed (e.g., in the background or offline) to generate various derived profile data. For example, if a user has provided information about various job titles that the user has held with the same organization or different organizations, and for how long, this information can be used to infer or derive a user profile attribute indicating the user's overall seniority level or seniority level within a particular organization.

Once registered, a user may invite other users, or be invited by other users, to connect via the social networking service. A “connection” may constitute a bilateral agreement by the users, such that both users acknowledge the establishment of the connection. Similarly, in some embodiments, a user may elect to “follow” another user. In contrast to establishing a connection, the concept of “following” another user typically is a unilateral operation and, at least in some embodiments, does not require acknowledgement or approval by the user that is being followed. When one user follows another, the user who is following may receive status updates (e.g., in an activity or content stream) or other messages published by the user being followed, relating to various activities undertaken by the user being followed. Similarly, when a user follows an organization, the user becomes eligible to receive messages or status updates published on behalf of the organization. For instance, messages or status updates published on behalf of an organization that a user is following will appear in the user's personalized data feed, commonly referred to as an activity stream or content stream. In any case, the various associations and relationships that the users establish with other users, or with other entities and objects, are stored and maintained within a social graph in a social graph database 220.

As users interact with the various applications, services, and content made available via the social networking service, the users' interactions and behavior (e.g., content viewed, links or buttons selected, messages responded to, etc.) may be tracked, and information concerning the users' activities and behavior may be logged or stored, for example, as indicated in FIG. 2, by the user activity and behavior database 222. This logged activity information may then be used by a search engine 216 to determine search results for a search query.

Although not shown, in some embodiments, a social networking system 210 provides an API module via which applications and services can access various data and services provided or maintained by the social networking service. For example, using an API, an application may be able to request and/or receive one or more recommendations. Such applications may be browser-based applications or may be operating system-specific. In particular, some applications may reside and execute (at least partially) on one or more mobile devices (e.g., phone or tablet computing devices) with a mobile operating system. Furthermore, while in many cases the applications or services that leverage the API may be applications and services that are developed and maintained by the entity operating the social networking service, nothing other than data privacy concerns prevents the API from being provided to the public or to certain third parties under special arrangements, thereby making the navigation recommendations available to third-party applications and services.

Although the search engine 216 is referred to herein as being used in the context of a social networking service, it is contemplated that it may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure.

In an example embodiment, when user profiles are indexed, forward search indexes are created and stored. The search engine 216 facilitates the indexing and searching for content within the social networking service, such as the indexing and searching for data or information contained in the data layer, such as profile data (stored, e.g., in the profile database 218), social graph data (stored, e.g., in the social graph database 220), and user activity and behavior data (stored, e.g., in the user activity and behavior database 222). The search engine 216 may collect, parse, and/or store data in an index or other similar structure to facilitate the identification and retrieval of information in response to received queries for information. This may include, but is not limited to, forward search indexes, inverted indexes, N-gram indexes, and so on.

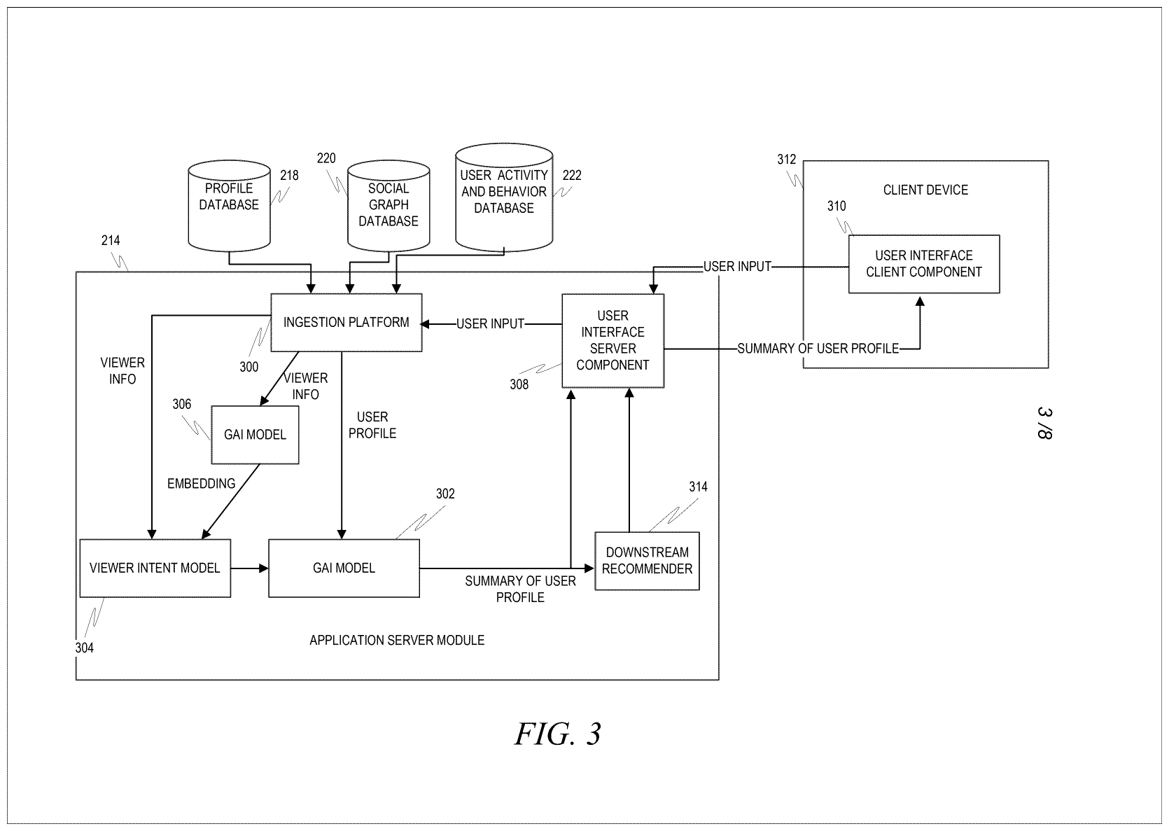

FIG. 3 is a block diagram illustrating the application server module 214 of FIG. 2 in more detail, in accordance with an example embodiment. While in many embodiments the application server module 214 will contain many subcomponents used to perform various actions within the social networking system 210, only those components that are relevant to the present disclosure are depicted in FIG. 3.

Here, an ingestion platform 300 obtains information from the profile database 218, the social graph database 220 and/or the user activity and behavior database 222. Which information it obtains and where it sends this obtained information depends on when it is being used. User profiles can be ingested by the ingestion platform 300 either at runtime (when the application server module 214 is attempting to obtain summary information from a user profile that it wishes to present to a viewer) or offline. By using an ingestion platform 300, information that will be needed to be used to summarize the user profile can be efficiency retrieved.

A user profile can then be sent to a GAI model 302 with instructions to generate a summary of the user profile. Viewer information can also be ingested by the ingestion platform 300 either at runtime or offline, although it may be beneficial to do so at runtime since it is possible that viewer intent may change over time and performing the ingestion (and ultimately the classification) of the viewer information at runtime allows for the most up-to-date classification of viewer intent. This viewer information may be passed to the viewer intent model 304, either directly or via a GAI model 306 (or both). As mentioned before, it is possible that the GAI model 306 and the GAI model 302 may be the same model.

The viewer intent model 304 identifies a viewer intent for the viewer, and this viewer intent is ultimately used to generate the summary of the user profile, allowing for the summary to be somewhat personalized for the viewer. More particularly, the viewer intent is used to focus the summarization to aspects that are considered to be likely to be important to the viewer. This may be accomplished in a number of ways. In one example embodiment, the viewer intent itself is passed as contextual input to the GAI model along with the user profile. Thus, for example, the GAI model may be instructed to generate a summary of the attached user profile for a viewer with the particular viewer intent, with the viewer intent and viewee profile being part of the prompt (as well as optionally the viewer's profile as well). In such a case, a generally trained GAI model may be used to generate user profile summaries across a variety of different categories of viewer intent. This provides the advantage of the GAI model being able to generate the summary of the user profile in a way that is customized to the viewer, or more specifically to the viewer's intent.

A prompt is an input provided to a GAI model to cause the GAI model to perform a generation process. In many instances this prompt is text based. The prompt typically includes instructions as to what the GAI model should generate and also includes, or at least points to, contextual information, meaning auxiliary information that is believed to be helpful for the GAI model in generating whatever it is the user wants the GAI model to generate.

Alternatively, a separate GAI model (either completely separately trained or trained using some shared training and then fine-tuned separately) may be utilized for each viewer intent category. Here, for example, once the viewer intent is determined, the GAI model corresponding to that viewer intent is retrieved and used to perform the actual summarization of the user profile.

Regardless, in some example embodiments the user profile summary is sent to a user interface server component 308, which then presents it to the viewer via a user interface client component 310 running on client device 312. Alternatively, the user profile summary may be sent to a downstream recommender 314, which makes a recommendation to the user based on the summary.

It should be noted that while FIG. 3 depicts various components executing on an application server module, some of these components may, in some example embodiments, be located on a client device rather than an application server module 214, such as client device 312 of FIG. 3. For example, the GAI model 302 and/or the viewer intent model 304 may be located on the client device 312, while still performing the same or similar operations as when they are included in the application server module 214. Additionally, in some example embodiments, the GAI models 302, 306 may individually or collectively be located at an external entity. Thus, for example, the GAI models 302, 306 may be managed by a third-party different from the entity managing the application server module 214. In such embodiments, a conversation agent may be included in the application server module 214 for interaction with the third-party GAI models 302, 306. Hybrid approaches are also possible, such as where a pre-trained GAI model 302, 306 is located at a third-party entity but a fine-tuned version or layer of the GAI model 302, 306 is located in the application server module 214.

The viewer actions that trigger the delivery of a user profile summary may vary from embodiment to embodiment, as well as based on viewer channels or other graphical user interface aspects. In some embodiments, for example, a user profile summary is generated when a viewer navigates to a screen in which a user profile is listed as being available to view. For example, the viewer may be a recruiter performing a search for possible job candidates that meet some criteria. A summary screen listing highlights of each identified job candidate may then be presented that includes the corresponding user profile summaries, and the viewer can click on one of them to see the full user profile. In another example, the viewer can explicitly request a summarization of a user profile, such as by selecting a “summary” button at the top of a user profile being viewed.

Alternatively, the user profile summary may be presented based on more indirect action or even no action on the part of the viewer. For example, a viewer may log in and then be presented with a summaries of user profiles of other users the system thinks the viewer may be interested in connecting with. In other examples, emails or other communications may be sent to the viewer without any action on the part of the user, including summaries of user profiles the system thinks the viewer may be interested in for some reason.

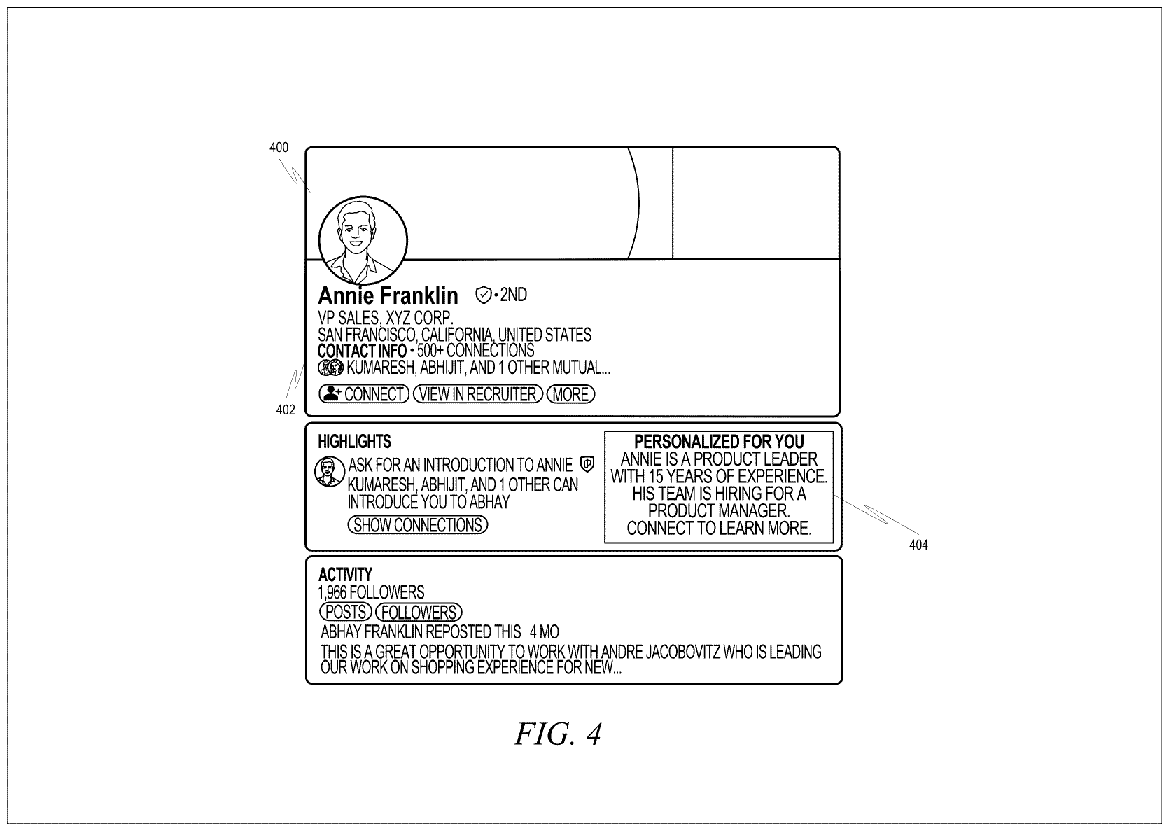

The GAI model 302 could be multi-modal and generate different types of formats for the summary, depending upon the viewer intent. For example, rather than merely text summaries a separate format of summary could be generated, such as a video summary. In another example, where the user profile include a video, the GAI model 302 is capable of generating a text summary based on the viewer intent. Furthermore, the generation of the summary can itself be performed in a number of ways. In some example embodiments, the summarization involves filtering out aspects of the viewee profile that the GAI model 302 has determined not to be relevant (or relevant enough) to viewers having the determined viewer intent. Filtering out involves removing elements of the user profile that are deemed not to be relevant, or at least not relevant enough, for display to the viewer. The result is a condensed version of the user profile being displayed to the viewer. In other example embodiments, actual text providing a summary of the viewee profile is generated by the GAI model and included as part of, or the complete, summary of the viewee profile. This text is a new representation of a summary, or jist, of the relevant portions of the user profile. FIG. 4 is a screen capture illustrating a first user interface 400, in accordance with an example embodiment. Here, a viewer may have navigated to view a particular user's profile page 402, but instead of being presented with the entire user profile for the corresponding user, a personalized summary 404 is generated and presented to the viewer.

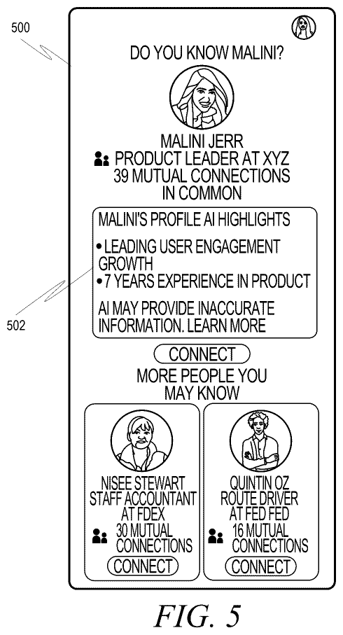

FIG. 5 is a screen capture illustrating a second user interface 500, in accordance with an example embodiment. Here, a viewer may have simply logged into an online service, and then was presented with a “people you may know” screen in which a summary 502 of a user that the viewer may know and thus may wish to connect with is presented. More particularly, in past systems, a “people you may know” screen may have been presented with a link to the viewees user profile as a whole, which the viewer could elect to select to view the viewees entire profile. In contrast, using the embodiments described herein, there is no need for the viewer to select such a link because the relevant information from or about the viewees profile has been provided as summary 502. Additionally, based on the relevant summary, the viewer is provided.

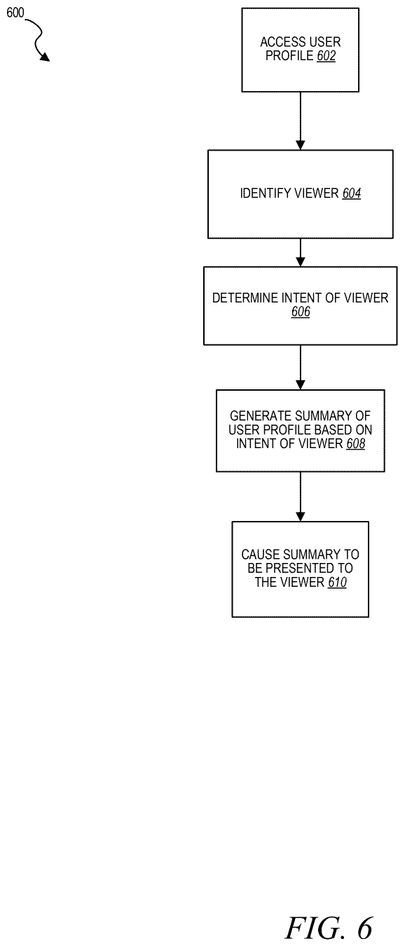

FIG. 6 is a flow diagram illustrating a method 600 for generating a summary of a user profile, in accordance with an example embodiment. At operation 602, a user profile stored in an online system is accessed. At operation 604, a viewer to be presented with information from the user profile is identified. At operation 606, a user intent for the viewer is determined. At operation 608, a summary of the user profile is generated based on the determined user intent. At operation 610, the summary is caused to be presented to the viewer.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

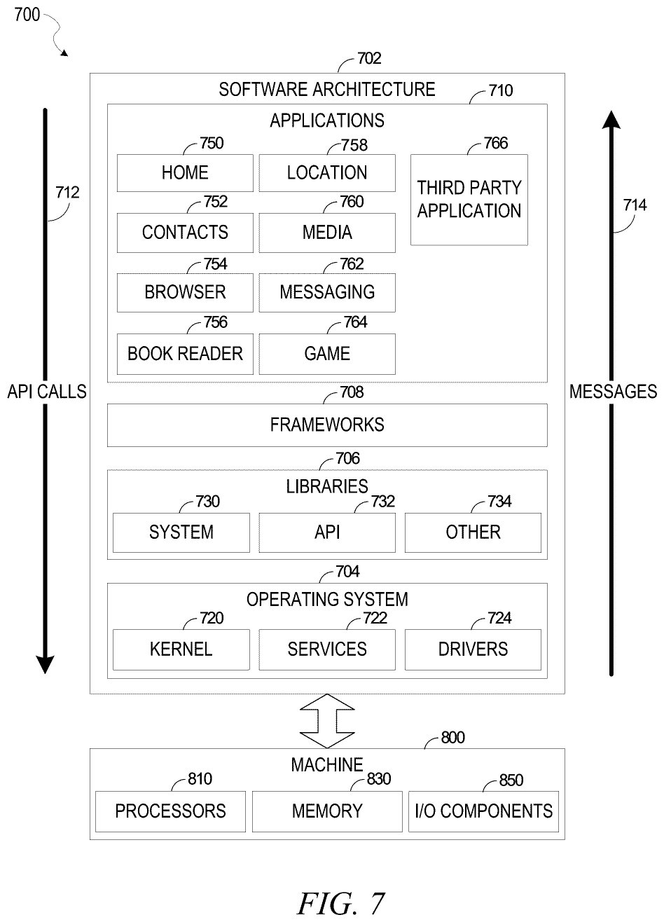

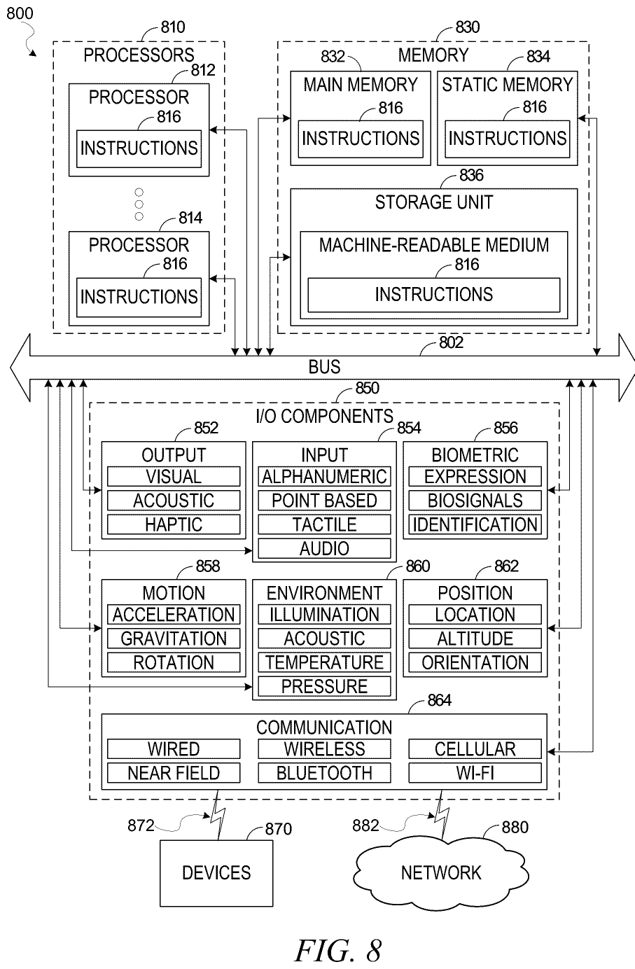

FIG. 7 is a block diagram 700 illustrating a software architecture 702, which can be installed on any one or more of the devices described above. FIG. 7 is merely a non-limiting example of a software architecture, and it will be appreciated that many other architectures can be implemented to facilitate the functionality described herein. In various embodiments, the software architecture 702 is implemented by hardware such as a machine 800 of FIG. 8 that includes processors 810, memory 830, and input/output (I/O) components 850. In this example architecture, the software architecture 702 can be conceptualized as a stack of layers where each layer may provide a particular functionality. For example, the software architecture 702 includes layers such as an operating system 704, libraries 706, frameworks 708, and applications 710. Operationally, the applications 710 invoke API calls 712 through the software stack and receive messages 714 in response to the API calls 712, consistent with some embodiments.

In various implementations, the operating system 704 manages hardware resources and provides common services. The operating system 704 includes, for example, a kernel 720, services 722, and drivers 724. The kernel 720 acts as an abstraction layer between the hardware and the other software layers, consistent with some embodiments. For example, the kernel 720 provides memory management, processor management (e.g., scheduling), component management, networking, and security settings, among other functionalities. The services 722 can provide other common services for the other software layers. The drivers 724 are responsible for controlling or interfacing with the underlying hardware, according to some embodiments. For instance, the drivers 724 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 706 provide a low-level common infrastructure utilized by the applications 710. The libraries 706 can include system libraries 730 (e.g., C standard library) that can provide functions such as memory allocation functions, string manipulation functions, mathematic functions, and the like. In addition, the libraries 706 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 706 can also include a wide variety of other libraries 734 to provide many other APIs to the applications 710.

The frameworks 708 provide a high-level common infrastructure that can be utilized by the applications 710, according to some embodiments. For example, the frameworks 708 provide various graphical user interface functions, high-level resource management, high-level location services, and so forth. The frameworks 708 can provide a broad spectrum of other APIs that can be utilized by the applications 710, some of which may be specific to a particular operating system 704 or platform.

In an example embodiment, the applications 710 include a home application 750, a contacts application 752, a browser application 754, a book reader application 756, a location application 758, a media application 760, a messaging application 762, a game application 764, and a broad assortment of other applications, such as a third-party application 766. According to some embodiments, the applications 710 are programs that execute functions defined in the programs. Various programming languages can be employed to create one or more of the applications 710, structured in a variety of manners, such as object-oriented programming languages (e.g., Objective-C, Java, or C++) or procedural programming languages (e.g., C or assembly language). In a specific example, the third-party application 766 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 766 can invoke the API calls 712 provided by the operating system 704 to facilitate functionality described herein.

FIG. 8 illustrates a diagrammatic representation of a machine 800 in the form of a computer system within which a set of instructions may be executed for causing the machine 800 to perform any one or more of the methodologies discussed herein, according to an example embodiment. Specifically, FIG. 8 shows a diagrammatic representation of the machine 800 in the example form of a computer system, within which instructions 816 (e.g., software, a program, an application 710, an applet, an app, or other executable code) for causing the machine 800 to perform any one or more of the methodologies discussed herein may be executed. For example, the instructions 816 may cause the machine 800 to execute the method 600 of FIG. 6. Additionally, or alternatively, the instructions 816 may implement FIGS. 1-6, and so forth. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors 810 that may comprise two or more independent processors 812 (sometimes referred to as “cores”) that may execute instructions 816 contemporaneously. Although FIG. 8 shows multiple processors 810, the machine 800 may include a single processor 812 with a single core, a single processor 812 with multiple cores (e.g., a multi-core processor), multiple processors 810 with a single core, multiple processors 810 with multiple cores, or any combination thereof.

The memory 830 may include a main memory 832, a static memory 834, and a storage unit 836, all accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may include a wide variety of components to receive input, provide output, produce output, transmit information, exchange information, capture measurements, and so on. The specific I/O components 850 that are included in a particular machine 800 will depend on the type of machine 800. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion, and the grouping is in no way limiting. In various example embodiments, the I/O components 850 may include output components 852 and input components 854. The output components 852 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 862 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a USB).

Moreover, the communication components 864 may detect identifiers or include components operable to detect identifiers. For example, the communication components 864 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 830, 832, 834, and/or memory of the processor(s) 810) and/or the storage unit 836 may store one or more sets of instructions 816 and data structures (e.g., software) embodying or utilized by any one or more of the methodologies or functions described herein. These instructions (e.g., the instructions 816), when executed by the processor(s) 810, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 816 and/or data. The terms shall accordingly be taken to include, but not be limited to, solid-state memories, and optical and magnetic media, including memory internal or external to the processors 810. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 880 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 816 may be transmitted or received over the network 880 using a transmission medium via a network interface device (e.g., a network interface component included in the communication components 864) and utilizing any one of a number of well-known transfer protocols (e.g., HTTP). Similarly, the instructions 816 may be transmitted or received using a transmission medium via the coupling 872 (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one processor; and
at least one non-transitory computer-readable medium having instructions stored thereon, which, when executed by the at least one processor, cause the system to perform operations comprising:
accessing content associated with a first entity;
identifying a second entity associated with the first entity, the second entity to be presented with information based on the content;
determining an intent for the second entity for engaging with an online system; and
passing the content into a generative artificial intelligence (GAI) model, the GAI model generating a summary based on the determined intent and the content.

2. The system of claim 1, wherein a prompt for generating the summary includes the content and the determined intent.

3. The system of claim 2, wherein the generating of the summary further comprises passing the determined intent into the GAI model as a contextual input to the GAI model.

4. The system of claim 2, wherein the GAI model uniquely corresponds to the determined intent and has been trained specifically to generate summaries for viewers with the determined intent.

5. The system of claim 1, wherein the determining a user intent includes using a machine learning model trained to classify user intent for a user based on information about the user.

6. The system of claim 5, wherein the machine learning model takes as input one or more features corresponding to a user.

7. The system of claim 6, wherein the summary is in a different format than the content.

8. The system of claim 7, wherein the one or more features include an embedding generated by a GAI model based on a profile for the user.

9. The system of claim 7, wherein the one or more features include user activity information.

10. The system of claim 1, wherein the operations further comprise:
passing the summary to a downstream recommender machine learning model to cause determination of a recommendation to the second entity based in part on the summary.

11. A method comprising:
accessing content associated with a first entity;
identifying a second entity associated with the first entity, the second entity to be presented with information based on the content;
determining an intent for the second entity for engaging with an online system; and
passing the content into a generative artificial intelligence (GAI) model, the GAI model generating a summary based on the determined intent and the content.

12. The method of claim 11, wherein a prompt for generating the summary includes the content and the determined intent.

13. The method of claim 12, wherein the generating of the summary further comprises passing the determined intent into the GAI model as a contextual input to the GAI model.

14. The method of claim 12, wherein the GAI model uniquely corresponds to the determined intent and has been trained specifically to generate summaries for viewers with the determined intent.

15. The method of claim 11, wherein the determining a user intent includes using a machine learning model trained to classify user intent for a user based on information about the user.

16. The method of claim 15, wherein the machine learning model takes as input one or more features corresponding to a user.

17. The method of claim 16, wherein the summary is in a different format than the content.

18. The method of claim 16, wherein the one or more features include an embedding generated by a GAI model based on a profile for the user.

19. The method of claim 16, wherein the one or more features include user activity information.

20. A non-transitory machine-readable storage medium comprising instructions which, when implemented by one or more machines, cause the one or more machines to perform operations comprising:
accessing content associated with a first entity;
identifying a second entity associated with the first entity, the second entity to be presented with information based on the content;
determining an intent for the second entity for engaging with an online system; and
passing the content into a generative artificial intelligence (GAI) model, the GAI model generating a summary based on the determined intent and the content.
